(19) United States
(12) Patent Application Publication
(10) Pub. No.: US 2012/0124050 A1
(43) Pub. Date: May 17, 2012

(54) SYSTEM AND METHOD FOR HS CODE RECOMMENDATION

(75) Inventors: Kyung-Ah YANG, Daejeon (KR); Moonyoung CHUNG, Daejeon (KR); Kyong-I KU, Daejeon (KR)

(73) Assignee: Electronics and Telecommunications Research Institute, Daejeon (KR)

(21) Appl. No.: 13/297,689

(22) Filed: Nov. 16, 2011

(30) Foreign Application Priority Data
Nov. 16, 2010 (KR) 10-2010-0113890

(51) Int. Cl. G06F 17/30

(52) U.S. Cl. 707/739; 707/E17.099

(57) ABSTRACT

A system for harmonized commodity description and coding system (HS) code recommendation includes an ontology editor for creating an HS code ontology based on HS codes of export and import items, and a feature vector processor for extracting feature vectors of a product of a company requesting for an HS code of the product by with reference to the description of the product in response to the request. An HS code recommendation unit extracts one or more HS codes appropriate for the product by comparing the extracted feature vectors with feature vectors of the product searched from a feature vector database. The extracted HS codes are provided to the company requesting for an HS code of the product.

### CROSS-REFERENCE TO RELATED APPLICATION(S)

The present invention claims priority of Korean Patent Application Nos. 10-2010-0113890, filed on Nov. 16, which is incorporated herein by reference.

### FIELD OF THE INVENTION

The present invention relates to a service for assigning a harmonized commodity description and coding system (hereinafter referred to as an HS) code used for a origin source determination for products, and more particularly, to an ontology-based system and method for HS code recommendation based on ontology when assigning an HS code to a product.

### BACKGROUND OF THE INVENTION

Recently, Korea has concluded free trade agreements (FTA) with 14 countries as it is pursuing the policy of diversification of FTA partnerships, and it is anticipated to extend to about 50 countries including the USA and EU which are large economic areas since 2010 and in the future. FTA may boost export growth, manufacturing, and an employment promotion, playing the motive power for the growth of Korea. In order to maximize business profits in relation to the effectuation of FTA, there occurs a demand for more thorough and strict origin source management. To this end, many companies launched the classification of export items.

In order to obtain tariff benefits with respect to exports in relation to the effectuation of FTA, a harmonized commodity description and coding system (HS) code is granted to export articles. The term ‘HS code’ refers to a product classification code granted to internationally traded goods based on a HS convention. For a product classification, for example, Korea uses 10 digits with HS of Korea (HSK), the USA uses 10 digits, the EU and China use 8 digits, and Japan uses 9 digits. Among digits, 6 digits are commonly used internationally.

As there are currently a variety of FTAs concluded, the standard for determining the country of origin of the same article may vary with each FTA. The FTA determination standard is based on the standard of origin source determination for each HS code agreed between FTA-concluded countries. Due to this, the product classification of the articles concerned should be clearly done to determine the correct country of origin.

Currently, domestic companies tend to search in the related regulations or the internet, consult experts such as customs brokers, or gets official interpretation by the authorities concerned in order to assign HS codes, which are essential information for origin source determination, to export items. However, in case of searching HS codes through the internet, it is difficult to prove whether the persons in charge who have no background knowledge in the country of origin and product classification have assigned appropriate HS codes to all products. Moreover, checking of HS codes with the help of customs brokers is complicated in terms of procedure.

### SUMMARY OF THE INVENTION

In view of the above, the present invention provides a system and method for HS code recommendation based on ontology so that a user can assign an HS code to a product more easily and intelligently in determining a origin source.

In accordance with an aspect of the present invention, there is provided a system for harmonized commodity description and coding system (HS) code recommendation, the system including:

an ontology editor for creating an HS code ontology based on HS codes of export and import items;

an ontology database for storing the HS code ontology;

a feature vector database for storing feature vectors for the HS codes created based on the HS code ontology;

a feature vector processor for extracting feature vectors of a product of a company requesting for an HS code of the product by with reference to the description of the product in response to the request; and

an HS code recommendation unit for extracting one or more HS codes appropriate for the product by comparing the extracted feature vectors with feature vectors of the product searched from the feature vector database.

In accordance with another aspect of the present invention, there is provided a method for harmonized commodity description and coding system (HS) code recommendation, the method including:

creating an HS code ontology based on HS codes of export and import items, the HS code ontology being stored in an ontology database;

creating feature vectors for the HS codes based on the HS code ontology stored in the ontology database, the feature vectors being stored in a feature vector database;

extracting feature vectors of a product of a company requesting for an HS code of the product by referring to the description of the product in response to the request for an HS code of the product;

extracting one or more HS codes appropriate for the product by comparing the extracted feature vectors with feature vectors of the product searched from the feature vector database; and

recommending the extracted HS codes as the HS code of the product.

### BRIEF DESCRIPTION OF THE DRAWINGS

The above and other objects and features of the present invention will become apparent from the following description of embodiments, given in conjunction with the accompanying drawings, in which:

FIG. 1 shows a block diagram of a system for HS code recommendation based on ontology in accordance with an embodiment of the present invention;

FIG. 2 shows an example of creating an HS code ontology in accordance with the embodiment of the present invention;

FIG. 3 shows an example in which a product classification ontology for products is created in accordance with the embodiment of the present invention;

FIG. 4 is a flowchart explaining a process for extracting feature vectors by the HS code ontology in accordance with the embodiment of the present invention; and

FIG. 5 is a flowchart explaining a process for recommending an HS code based on ontology in accordance with the embodiment of the present invention.

### DETAILED DESCRIPTION OF THE EMBODIMENTS

Hereinafter, embodiments of the present invention will be described in detail with reference to the accompanying drawings.

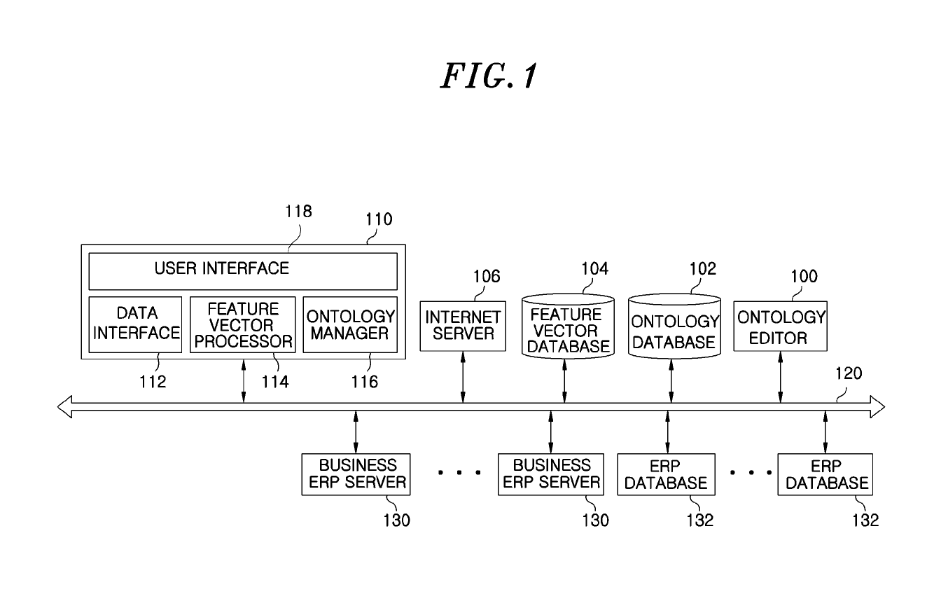

FIG. 1 shows a block diagram of a system for HS code recommendation based on ontology in accordance with an embodiment of the present invention. The HS code recommendation system includes an ontology editor 100, an ontology database 102, a feature vector database 104, an internet server 106, and an HS code recommendation unit 110. The HS code recommendation system further includes a plurality of business ERP servers 130, and ERP databases 132.

The ontology editor 100 creates an HS code ontology using HS codes and categories of products produced and managed by an individual company. The created HS code ontology is stored in the ontology database 102.

The ontology database 102 stores the HS code ontology, a product classification ontology and a domain ontology created by a domain expert. The product classification ontology constructs hierarchical relationship of product classification based on the categories of products used by companies. The product classification ontology may be created by importing data of HS codes in a database by the ontology editor 100, or may be created directly from the HS codes by a trade expert such as a customs broker.

The ontology editor 100 provides an interface configured to import data of HS codes and an interface configured for a trade expert such as a customs broker to create an HS code ontology. In other words, the ontology editor 100 creates an HS code ontology based on the hierarchical relationship of HS codes listed in the harmonized system, e.g., harmonized system of Korea (HSK) in which export and import items are classified into 11,261 in order to recommend HS codes. Also, the ontology editor 100 may create a product classification ontology for each product by mapping categories of products produced and/or managed by an individual company to classes in the product classification ontology based on the hierarchical relationship of the categories. More specifically, for the creation of an HS code ontology, one category is represented by a class based on the hierarchical relationship of the categories for products produced and/or managed by an individual company, and each product in the category is instanced to create the product classification ontology. The product classification ontology so created is stored in the ontology database 102.

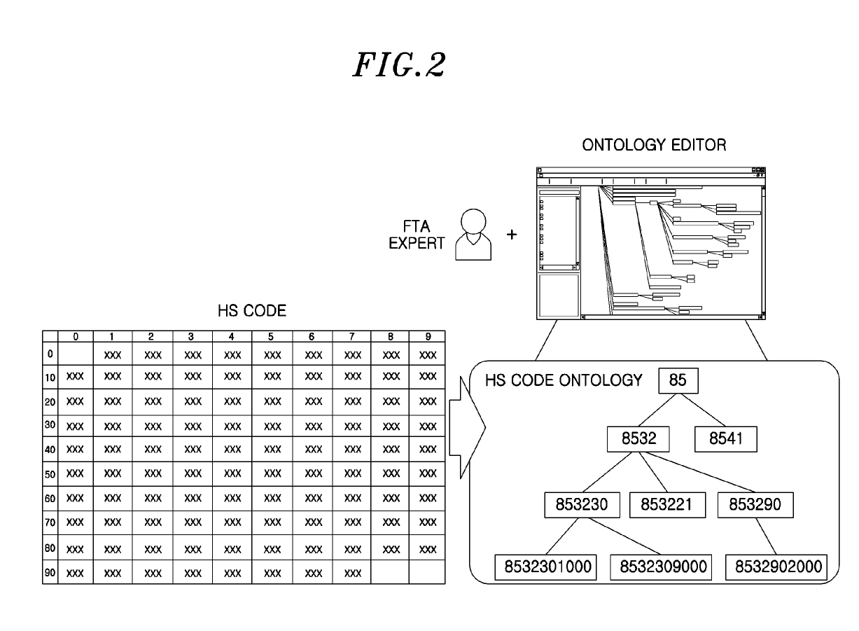

This process of creating an HS code ontology by the ontology editor 100 will be described in more detail with reference to FIG. 2.

FIG. 2 shows an example of creating an HS code ontology in accordance with the embodiment of the present invention.

In FIG. 2, a two(2)-digit HS code ‘85’ is the uppermost number in the ‘Electrical equipment/TV/VTR’ category, and may have one or more four(4)-digit lower sub-HS codes such as ‘8532’ and ‘8541’. The sub-HS code ‘8532’ is for ‘electrical capacitors’ and, in turn, the sub-HS code ‘8532’ also has lower sub-HS codes such as ‘853230’, ‘853221’ and so on. In this manner, a set of 11,261 HS codes may be represented by an ontology having a hierarchical relationship. One HS code is mapped to one ontology class, the HS code has description representing a attribute of an ontology class, which is stored separately.

Also, the product classification ontology may be created through the use of data of the ERP database 132 operated by the business ERP server 130. Stored in the ERP database 132 is information about manufactured products including information about the category-wise classification of the products of a company.

The HS recommendation unit 110 creates the product classification ontology by fetching category information of a desired product from the ERP database 132 by means of the data interface 112, figuring out the hierarchical relationship of the category information, and then importing data of the hierarchical relationship by the ontology editor 100.

Alternatively, an entity that are in charge of computational work in the company may create the product classification ontology representing the hierarchical relationship based on the category information of the products through the use of an interface provided by the ontology editor 100.

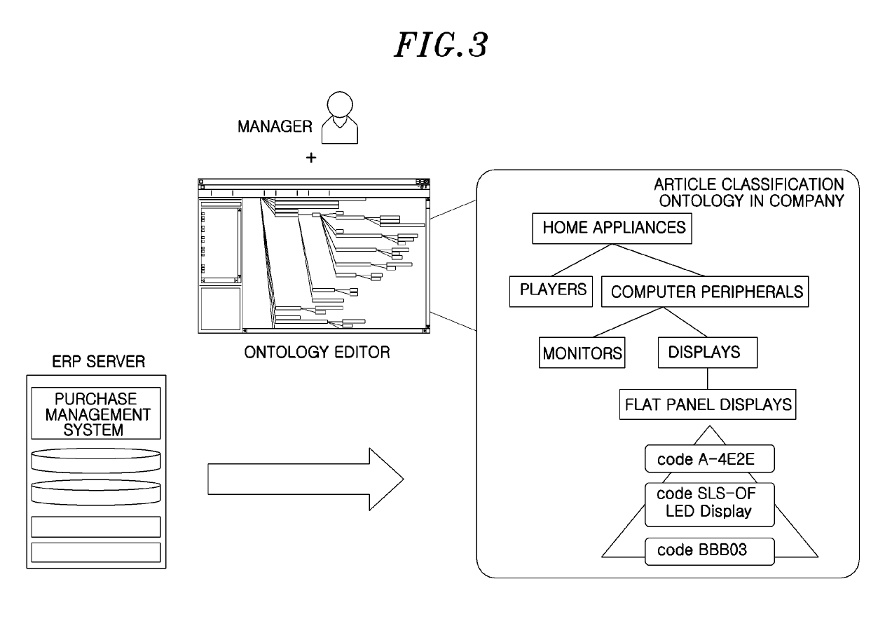

This process of creating the product classification ontology by the ontology editor 100 and the HS code recommendation device 100 will be described in detail with reference to FIG. 3. In FIG. 3, ‘home appliances’ is the top-level category of products in a specific company. The ‘home appliances’ has lower categories including ‘players’ and ‘computer peripherals’. Such architecture in a category can be represented by upper and lower layers of the ontology, and one category can be presented by one ontology class. At this point, the articles ‘code: A-4E2E’, ‘code: SLS-OF LED Display’, ‘code: BBB03’, etc. belonging to the ‘flat panel displays’ category are represented by instances belonging to a category ‘flat panel displays’.

Meanwhile, the domain ontology is a standardized ontology of a specific kind created by a domain expert. The domain ontology is well-known to those skilled in the art, so a detailed description of the configuration of the domain ontology will be omitted.

Referring back to FIG. 1, the internet server 106 performs the overall control of the ontology-based system for HS code recommendation. That is, the internet server 106 provides an HS code recommendation service in conjunction with the business ERP server 130 via a network 120.

The Hs code recommendation unit 110 receives descriptive information of products produced by each company in conjunction with the business ERP servers 130 and the ERP databases 132, and provides a service for recommending an HS code for each product based on the descriptive information. The HS code recommendation unit 110 includes a data interface 112, a feature vector processor 114, an ontology manager 116, and an HS code recommendation user interface 118.

The data interface 112 is a module that serves to operate in conjunction with the ERP database 132 operated by each company. The ontology manager 116 fetches an ontology stored in the ontology database 102, and performs ontology-related operations such as navigation, relational reasoning, and like.

The feature vector processor 114 extracts a set of feature vectors, i.e., keywords, from the description of each HS code and the explanation of each company's product, and calculates the similarity between the sets of keywords of the HS code and the product. More specifically, the feature vector processor 114 extracts the feature vectors for each class of the HS code ontology and of the product classification ontology, and then stores the extracted feature vectors in the feature vector database 104.

The feature vector database 104 stores the sets of feature vectors, which are the sets of keywords, extracted from the description for each HS code and the explanation for each company's product.

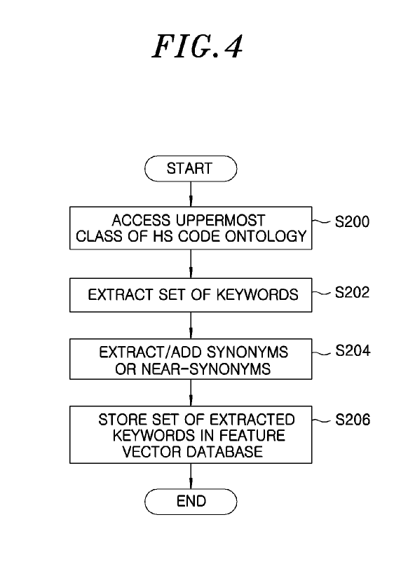

The process by which the feature vector processor 114 extracts feature vectors using an ontology stored in the ontology database 102 will be described with reference to the flowchart of FIG. 4.

First, in step 200, the feature vector processor 114 accesses the uppermost class of the HS code ontology. In a next step 202, the feature vector processor 114 applies a keyword extraction algorithm to the ‘description’ attribute of the respective uppermost class to extract keywords representative of an HS code in the uppermost class. A set of the extracted keywords becomes feature vectors representing the characteristics of the uppermost class.

After that, in step 204, the feature vector processor 114 extracts synonyms or near-synonyms by comparing the classes of the HS code ontology with the classes of the domain ontology, respectively. In other words, the feature vector processor 114 extracts classes common to both the HS code ontology and the domain ontology. If the extracted common classes in the domain ontology have synonyms or near-synonyms, these synonyms or near-synonyms are added to the corresponding common class of the HS code ontology. The synonyms or near-synonyms added to the class of the HS code ontology serves to supplement the previously generated feature vectors.

In this way, the classes of the HS code ontology can secure an abundant number of feature vectors through the use of comparison of the HS code ontology with the domain ontology in accordance with the embodiment of the present invention.

In step 206, the feature vector processor 114 stores the set of keywords extracted through these comparisons and the synonyms or near-synonyms added to each class as feature vectors in the feature vector database 104.

Meanwhile, the feature vector processor 114 generates no feature vectors for similar classes of the HS code ontology, but generates feature vectors for the ‘description’ attribute of an instance.

In this way, for the purpose of recommendation based on the ontology, the feature vector processor 114 extracts feature vectors from each class or instance, separately from the ontologies. That is, in order to extract keywords of each HS code from the HS code ontology, feature vectors are generated for the description part of HS codes listed in the harmonized system, and feature vectors for describing products represented by each instance are extracted from the product classification ontology. The thus-extracted feature vectors are stored in the feature vector database 104.

The feature vector processor 114 performs an operation for measuring the similarity between the feature vectors stored in the feature vector database 104 and the feature vectors of a product requested by a user or company requesting a HS code for a product. In this case, one or more HS codes having high similarity values with the sets of keywords, i.e., feature vectors, extracted from an individual product, is extracted by a similarity calculation algorithm, HS codes above a specific threshold are extracted from the extracted set of HS codes. The extracted HS codes are then provided to the user or company via the HS code recommendation user interface 118, thereby recommending the HS code.

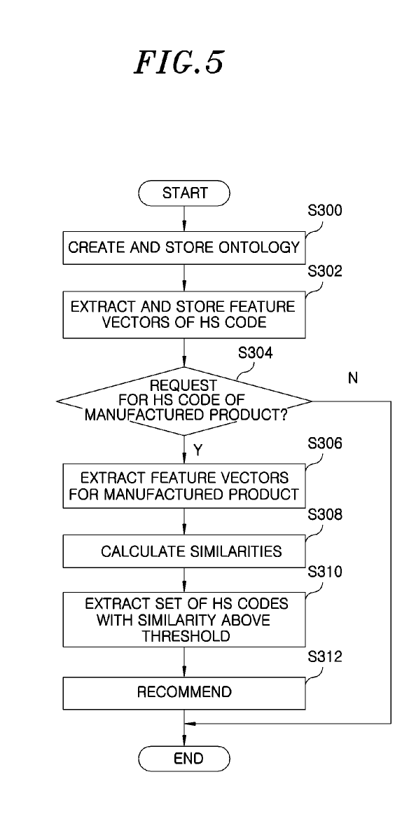

FIG. 5 is a flowchart explaining a process for recommending an HS code based on ontology in accordance with the embodiment of the present invention.

As shown in FIG. 5, first, in step 300, the ontology editor 100 creates an HS code ontology based on the hierarchical relationship between HS codes, and creates a product classification ontology using categorization information of products produced and managed by each company. The created HS code ontology and product classification ontology are stored, along with the domain ontology, in the ontology database 102. In this regard, when creating a product classification ontology for the products, the ontology editor 100 creates the product classification ontology by defining the name of the company's product as the name of an instance and detailed description of the product as an attribute of the instance.

Next, in step 302, the feature vector processor 114 extracts feature vectors for each class of the HS code ontology and also extracts feature vectors for the product using the attribute information of the product classification ontology, and stores the extracted feature vectors of HS codes in the feature vector database 104 of the product classification ontology. As set forth above, the feature vectors of the product classification ontology are generated by extracting keywords using the attribute information of the product classification ontology.

Thereafter, in step 304, it is determined whether or not a request for an HS code has been made for a product. If it is determined that an HS code request has been made, the feature vector processor 114 extracts feature vectors from the description of the product, and stores the extracted feature vectors in the feature vector database in step S306.

Next, in step 308, the similarities between the feature vectors of the product extracted by the feature vector processor 114 and the feature vectors of the product searched from the feature vector database 104 are calculated.

Subsequently, in step 310, one or more HS codes with a similarity above a predetermined threshold is extracted by comparing each of the calculated similarities with the predetermined threshold. Finally, in step 312, the extracted HS codes are then provided to the user requesting the HS code via the HS code recommendation user interface 118.

In accordance with the present invention, HS codes, which are essential information for determining the origin source of a manufactured product, are provided so that a person in charge of origin source labeling can easily assign the HS codes to products.

Moreover, the present invention can increase price competitiveness of domestic products associated with FTAs by enabling the manufacturers of raw materials required for each manufactured article and the manufacturers of products to assign HS codes to products easily by a development system operating in conjunction with a origin source management system.

While the invention has been shown and described with respect to the particular embodiments, it will be understood by those skilled in the art that various changes and modification may be made without departing from the scope of the invention as defined in the following claims.

What is claimed is:

1. A system for harmonized commodity description and coding system (HS) code recommendation, the system comprising:
an ontology editor for creating an HS code ontology based on HS codes of export and import items;
an ontology database for storing the HS code ontology;
a feature vector database for storing feature vectors for the HS codes created based on the HS code ontology;
a feature vector processor for extracting feature vectors of a product of a company requesting for an HS code of the product by with reference to the description of the product in response to the request; and
an HS code recommendation unit for extracting one or more HS codes appropriate for the product by comparing the extracted feature vectors with feature vectors of the product searched from the feature vector database.

2. The system of claim 1, wherein the HS code ontology is created based on the hierarchical relationship of HS codes listed in the harmonized system that discriminates the export and import items.

3. The system of claim 1, wherein the ontology editor is further configured to create a product classification ontology by defining categories of products as a class based on the hierarchical relationship between the categories, and instancing the products in the categories, and
wherein the created product classification ontology is stored in the ontology database.

4. The system of claim 3, wherein the feature vector processor is further configured to generate feature vectors of the product classification based on attribute information of instances in the product classification ontology, and
wherein the feature vectors of the product classification are stored in the feature vector database.

5. The system of claim 1, wherein the feature vector processor is configured to generate feature vectors for each class on the HS code ontology.

6. The system of claim 1, wherein the ontology database is further configured to store a domain ontology, and
the feature vector processor is further configured to extract synonyms or near-synonyms by comparing the classes of the HS code ontology with the classes of the domain ontology, respectively, and to add the extracted synonyms or near-synonyms to the corresponding class of the HS code ontology.

7. The system of claim 1, wherein the HS code recommendation unit is configured to calculate the similarities between the extracted feature vectors of the product and the feature vectors of the product searched from the feature vector database and extract the set of HS codes above a predetermined threshold from the calculated similarities, and
wherein the extracted HS codes are provided to the company requesting for an HS code of the product.

8. The system of claim 1, wherein the HS code recommendation unit further includes:
a business data interface operated in conjunction with an ERP database for receiving category information of products produced and managed by each company; and
an ontology manager for performing operations such as navigation or relational reasoning by an ontology stored in the ontology database.

9. A method for harmonized commodity description and coding system (HS) code recommendation, the method comprising:
creating an HS code ontology based on HS codes of export and import items, the HS code ontology being stored in an ontology database;
creating feature vectors for the HS codes based on the HS code ontology stored in the ontology database, the feature vectors being stored in a feature vector database;
extracting feature vectors of a product of a company requesting for an HS code of the product by referring to the description of the product in response to the request for an HS code of the product;
extracting one or more HS codes appropriate for the product by comparing the extracted feature vectors with feature vectors of the product searched from the feature vector database; and
recommending the extracted HS codes as the HS code of the product.

10. The method of claim 9, wherein the Hs code ontology is created based on the hierarchical relationship of HS codes listed in the harmonized system that classifies the export and import items.

11. The method of claim 9, further comprising:
receiving categories of products produced and managed by the company requesting for an HS code of the product;
defining the categories as classes based on the hierarchical relationship between categories; and
creating a product classification ontology by instancing each of the products in the categories; and
storing the product classification ontology in the ontology database.

12. The method of claim 9, further comprising:
creating a domain ontology, the domain ontology being stored in the feature vector database;
extracting synonyms or near-synonyms by comparing the classes of the HS code ontology with the classes of the domain ontology, respectively; and
adding the extracted synonyms or near-synonyms to the corresponding class of the HS code ontology.

13. The method of claim 9, wherein said extracting one or more HS codes appropriate for a product includes:
calculating the similarities between the extracted feature vectors of the product and the feature vectors of the product searched from the feature vector database; and
extracting HS codes above a predetermined threshold from the calculated similarities.
